(19) United States
(12) Patent Application Publication
(10) Pub. No.: US 2005/0257841 A1
(43) Pub. Date: Nov. 24, 2005

(54) Faucet apparatus

(76) Inventor: Bedros Najarian, Manhattan Beach, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/851,583

(22) Filed: May 20, 2004

(51) Int. Cl. F16K 11/02

(52) U.S. Cl. 137/625.4

(57) ABSTRACT

An outer housing having a faucet arm connected to a flow-through coupler, a water mixing and flow rate control device connected to the outer housing and disposed within the housing. Water flow rate and mixing of a first water source and a second water source are controlled by vertical and horizontal movement of the faucet arm.

### BACKGROUND

1. Field

This invention relates to faucets, and more particularly to a faucet with temperature and flow control within a single body.

2. Description of the Related Art

Many faucets exist today that have a spout, levers and valves to control water flow and temperature. Some faucets have automatic sensors to start water flow or foot pedals. These type of faucets allow hands-free operation and also help to prevent the spread of germs, viruses, etc. from being passed on to multiple users.

U.S. Pat. No. 6,321,788 issued to Egli includes a pivoting water outlet and a mixer valve next to the spout. The mixer valve controls flow and temperature by being rotated left and right. The mixer controls flow by being pulled toward a user or pushed away from a user. The mixer allows for one hand operation.

In U.S. Pat. No. 3,726,318 issued to Hyde, a mixer is connected to the spout, and the hot and cold water arms control flow. This allows a user to use other parts of their arm to turn the water flow off and on without using their hands. The hot and cold water control mixer, however, would need to be either preset to a desired temperature or turned by using a hand to set a desired temperature.

### SUMMARY

One embodiment includes an apparatus having a control arm with a position control brake and a flow rate control inlet. The control arm has a water passage way through the length of the control arm from the flow rate control inlet to an end outlet. A first housing and a second housing are coupled to the control arm. The first housing includes a mixed water outlet. The second housing has a position control brake. A first base is rotatably coupled to a second base. The second base is coupled to the first housing and the second housing. The control arm controls mixing of hot and cold water and water flow rate.

Another embodiment includes a faucet having a housing with a faucet arm coupled to a top of the housing. A water mixing and flow rate control device is coupled to the housing and disposed within the housing. Water flow rate and mixing of a first water source and a second water source are controlled by vertical and horizontal movement of the faucet arm.

### BRIEF DESCRIPTION OF THE DRAWINGS

The embodiments are illustrated by way of example and not by way of limitation in the figures of the accompanying drawings in which like references indicate similar elements. It should be noted that references in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments,” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

FIG. 1 illustrates a side view of a device used within a faucet for controlling temperature mixing of hot and cold water and for controlling flow rate.

FIG. 2 illustrates the device illustrated in FIG. 1 in the full “on” position.

FIG. 3 illustrates a front view of the device illustrated in FIG. 1.

FIG. 4 illustrates a flow-through coupler having an opening.

FIG. 5A illustrates a housing for the device illustrated in FIG. 1 coupled with a flow-through coupler and with faucet arm in the “off” position.

FIG. 5B illustrates a housing for the device illustrated in FIG. 1 coupled with a flow-through coupler with faucet arm in the “on” position.

FIG. 6 illustrates a bottom view of a lower base of the device illustrated in FIG. 1.

FIG. 7 illustrates a top view of the lower base illustrated in FIG. 6.

FIG. 8 illustrates a bottom view of an upper base of the device illustrated in FIG. 1.

FIG. 9 illustrates a top view of the lower base and the upper base with a left housing showing and without illustrating the rest of the device illustrated in FIG. 1.

FIG. 10A illustrates a side view of a control arm having a flow control opening being shown.

FIG. 10B illustrates a bottom side view of the control arm illustrated in FIG. 10A.

FIG. 10C illustrates a side view of the control arm illustrated in FIG. 10A showing the flow path from control flow opening through the control arm.

FIG. 11A illustrates a side view of the device illustrated in FIG. 1 with the right housing removed.

FIG. 11B illustrates an isolated view of the right housing.

FIG. 11C illustrates a side view close-up of the device illustrated in FIG. 1 with the right housing removed exposing the position control brake.

### DETAILED DESCRIPTION

The invention generally relates to a faucet apparatus. Referring to the figures, exemplary embodiments of the invention will now be described. The exemplary embodiments are provided to illustrate the invention and should not be construed as limiting the scope of the invention.

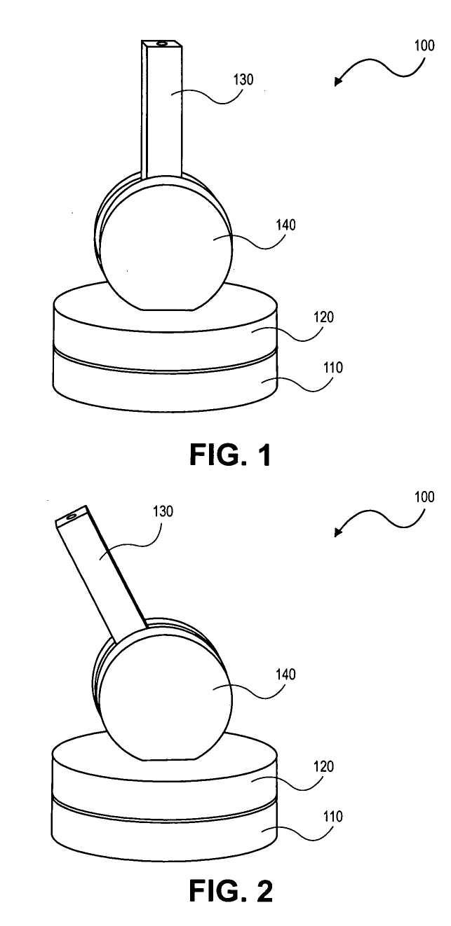

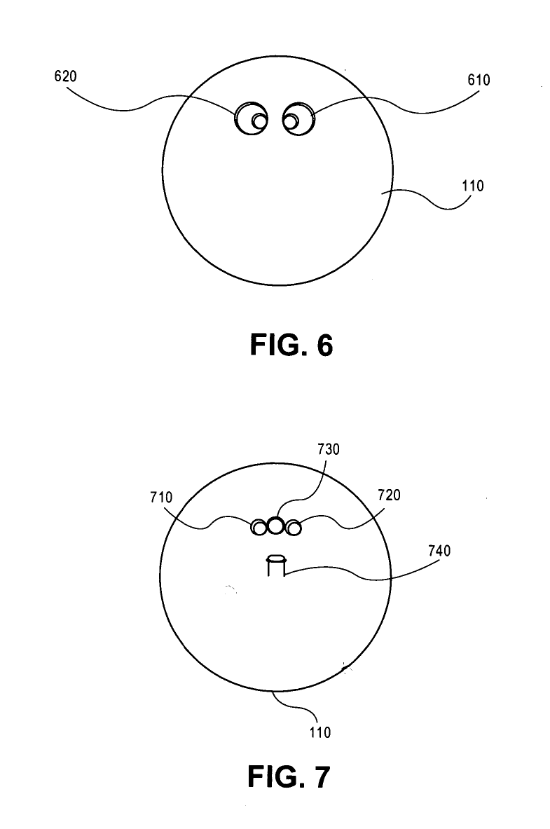

FIG. 1 illustrates a side view of a device used within a faucet for controlling temperature mixing of hot and cold water and for controlling flow rate. Device 100 includes lower base 110, upper base 120 control arm 130 and right housing 140. Lower base 110 and upper base 120 are rotatably coupled to one another. Rotation of the bases with respect to each other controls mixing of hot and cold water. Hot and cold water flows through lower base 110 through separate inlets (illustrated in FIG. 6). In one embodiment lower base 110 and upper base 120 are made of Teflon® and form a self-sealing connection between lower base 110 and upper base 120. A grooved mixing depression in upper base 120 covers inlets on lower base 110. When upper base 120 rotates in relation to lower base 110, the inlets are either covered, uncovered, or partially uncovered, which allows hot water, cold water, or a mix of hot water and cold water to flow through upper base 120. In one embodiment, when control arm 130 is perpendicular to a top of base 120 (as illustrated in FIG. 1) device 100 is in the “off” position (no flow of water).

In one embodiment, upper base portion and lower base portion are Teflon® coated and adhere to one another. In one embodiment, upper and lower base portions are made of a hardened plastic material. In another embodiment, upper and lower bases are made of a metal (e.g., brass, stainless steel, etc.) or metal alloy. In yet another embodiment, the elements of device 100 can all be any combination of plastics, metal and metal alloy, including all elements being any of the aforementioned. In another embodiment upper base 120 and lower base 110 have an o-ring between the bases near the exterior edge with a groove the o-ring sits into to prevent leakage.

FIG. 2 illustrates device 100 illustrated in the full “on” position (i.e., maximum water flow rate). Any position for control arm 130 between the full “on” position (FIG. 2) and the “off” position (FIG. 1) has a flow rate between full and off. In one embodiment, the “off” position is at a 90 degree angle in reference to the upper and lower bases, and the full “on” position is at or near 60 degrees (i.e., approximately 30 degree range). It should be noted that other embodiments can have different ranges of motion for control arm 130.

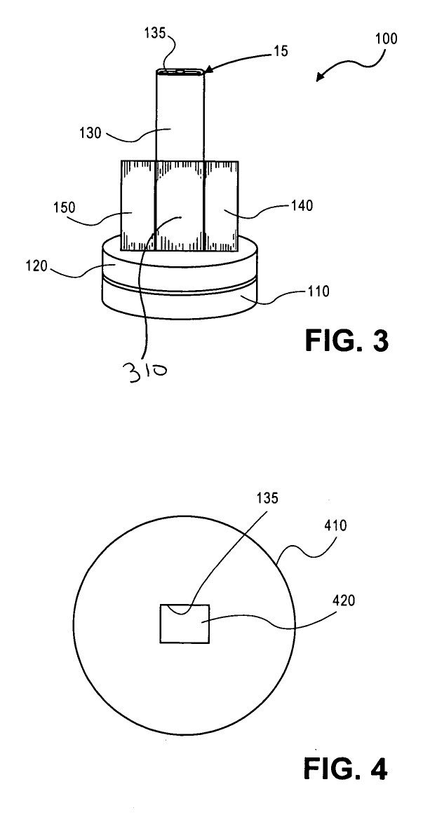

FIG. 3 illustrates a front view of device 100. As illustrated in FIG. 3, control arm 130 has lower portion 310. Lower portion 310 is rotatably coupled between left housing 150 and right housing 140. In one embodiment control arm 130 is coupled to gasket 135 to prevent leakage between control arm 130 and a flow-through coupler (illustrated in FIG. 4).

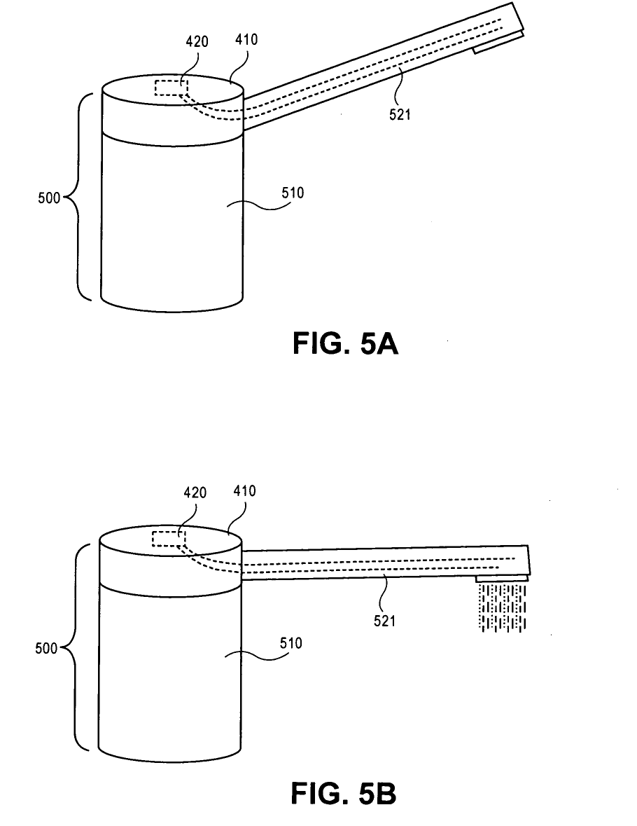

FIG. 4 illustrates flow-through coupler 410 having an opening 420. One should note that while control arm 130 and opening 420 are illustrated having a square or rectangular shape, that control arm 130 and opening 420 can be other complimentary shapes in other embodiments, such as circular, triangular, etc. Flow-through coupler 410 is made of similar materials as device 100. Flow-through coupler 420 is coupled to housing 500 (illustrated in FIGS. 5A and 5B).

FIG. 5A illustrates housing 500 coupled to faucet arm 521 and shown in the “off” position. Device 100 is coupled within housing 500. Control arm 130 couples with flow-through coupler 410 through opening 420. As illustrated, the dashed lines represent water flow within housing 500, flow-through coupler 410 and faucet arm 521. As faucet arm 521 is forced down, control arm 130 and flow-through coupler 410 are also forced down (flow-through coupler 410 rotates forward, back and side to side on housing 500) causing control arm 130 to move from the “off” position to an “on” position. As faucet arm 521 is moved either to the left or to the right, water temperature is adjusted by mixing hot and cold water. Housing 500 (including flow-through coupler 410, body 500) can be made of various materials similar to device 100. One should note that while FIGS. 5A and 5B illustrates housing 500 as cylindrical, other shapes can be used without varying from the other embodiments, such as ornamental shapes, traditional faucet shapes, etc. FIG. 5B illustrates housing 500 coupled to faucet arm 521 and shown in the “on” position. In another embodiment, the “off” and “on” positions can be reversed.

FIG. 6 illustrates a bottom view of lower base 110. Water inlets 610 and 620 allow hot and cold water lines to flow through base 110 to base 120. In one embodiment water lines are connected to water inlets 610 and 620. Traditional plumbing can be used to connect device 100 to hot and cold water lines. Rubber o-rings (not shown) are removably coupled to each water inlet to prevent leakage.

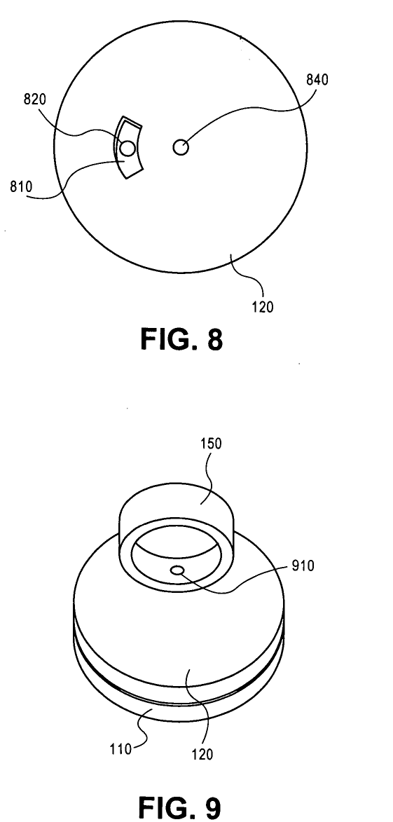

FIG. 7 illustrates a top view of base 110. Water outlets 710 and 720 are of a smaller diameter than water inlets 610 and 620 (illustrated in FIG. 6). Centering pin 740 aligns lower base 110 with upper base 120 for a secure fit of the bases. Centering pin 740 fits within centering hole 840 (illustrated in FIG. 8). In one embodiment, centering pin 740 is approximately 4 mm in height and 6 mm in diameter. It should be noted that other proportional dimensions for centering pin 740 (and also centering hole 840) can be used as well. Mixing pin 730 fits into mixing groove 810, but is of a height allowing for water to pass through (i.e., mixing pin 730 will not block mixing inlet 820) mixing inlet 820 from water outlets 710 and 720.

FIG. 8 illustrates a bottom view of base 120. Centering hole 840 couples to centering pin 740 to align base 110 with base 120 for a secure fit. Mixing groove 810 allows hot and cold water to mix together when base 120 is rotated. That is, mixing groove 810 can be rotated toward the hot or cold water outlets (710 and 720) to either block or allow water to flow into mixing groove 810.

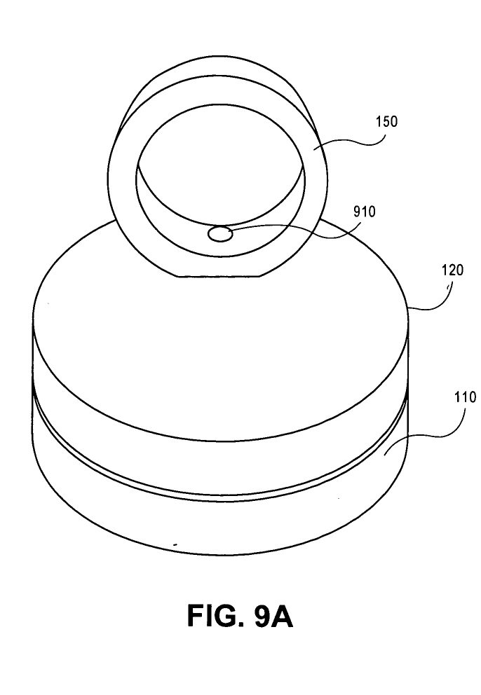

FIG. 9 illustrates a top view of base 110 and base 120 with left housing 150 showing and without illustrating the rest of device 100. Mixed water flow outlet 910 passes mixed water from mixing inlet 820 to allow for flow rate adjustment. FIG. 9A illustrates a close-up of FIG. 9.

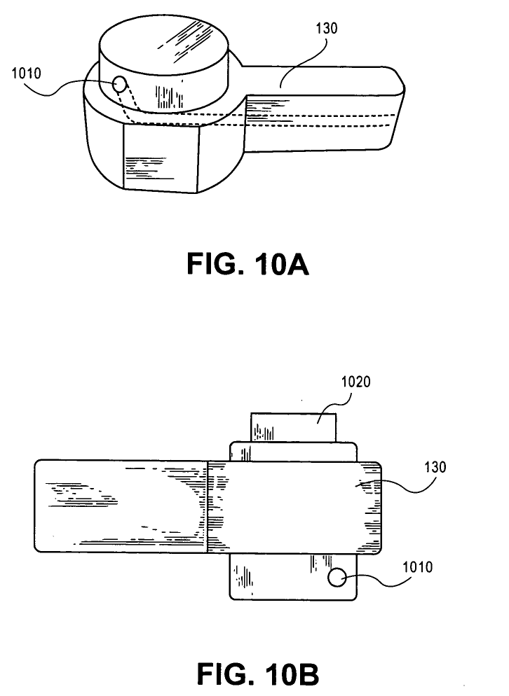

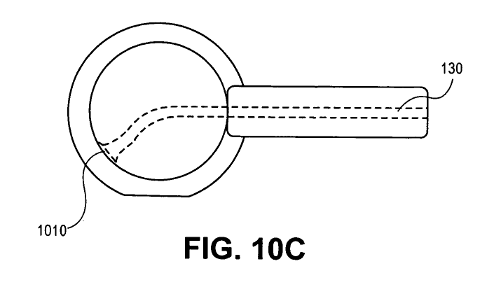

FIG. 10A illustrates a side view of control arm 130 with flow control opening 1010 being shown. Flow control opening 1010 allows water to flow from mixed water flow outlet 910 to pass through a conduit formed within control arm 130 when control arm 130 is rotated to align flow control opening 1010 with water flow outlet 910. When flow control opening 1010 is directly aligned with water flow outlet 910, maximum flow rate is achieved. When control arm 130 is moved downward from an upright position, flow control opening 1010 rotates to cover water flow outlet 910, which allows water to flow through control arm 130. As control arm 130 is moved toward the upright position, flow control opening 1010 becomes misaligned with water flow outlet 910, which reduces water flow through control arm 130. When control arm 130 is in the absolute upright position, flow control opening 1010 is offset from water flow outlet 910 and water flow is blocked (“off” position). In one embodiment, a rubber o-ring is fitted within flow control opening 1010 to prevent leakage when in the “off” position.

FIG. 10B illustrates a bottom side view of control arm 130. Position control brake 1020 limits rotational movement of control arm 130. Position control brake 1020 fits within right housing 140. FIG. 10C illustrates a side view of control arm 130 showing the flow path from control flow opening through control arm 130.

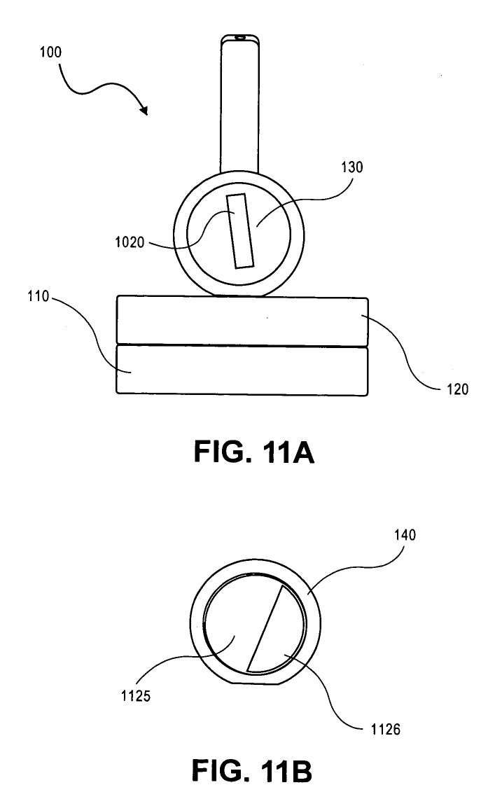

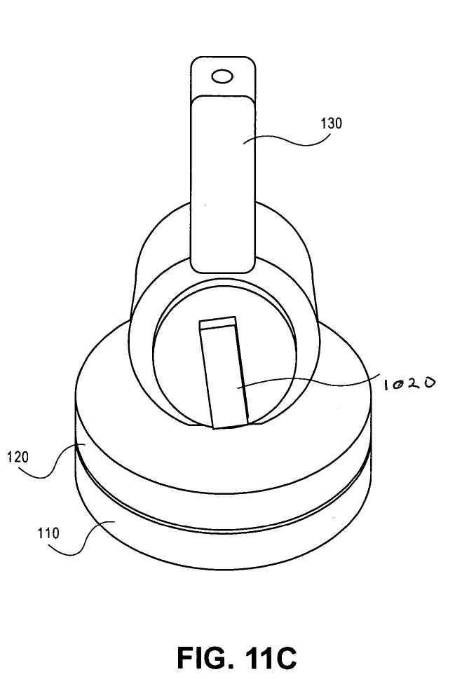

FIG. 11A illustrates a side view of device 100 with right housing 140 removed to show position control brake 1020. Position control brake 1020 fits within right housing 140 in hollowed portion 1125 and adjacent to brake stop 1126. As control arm 130 is rotated to the “on” position or moved to the “off” position, position control brake 1020 is limited in movement by brake stop 1126. FIG. 11B illustrates an isolated view of right housing 140. FIG. 11C illustrates a side view close-up of device 100 with right housing 140 removed exposing position control brake 1020.

Device 100 and its various components can be made by manufacturing techniques known to those skilled in the art, such as injection molding, over molding, pultrusion, extrusion, casting, welding, machining, etc. It should also be noted that device 100 can be made by hand, robotics or a combination of both. Device 100 can be made in various sizes. The size of device 100 can be adapted depending on desired use of device 100, e.g., residential, commercial use, hospital use, etc. In one embodiment, device 100 is sized to fit within faucet housings typically found in residential or commercial bathrooms and kitchens.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. An apparatus comprising:
a control arm having a position control brake and a flow rate control inlet, said control arm having a water passage way through the length of said control arm from said flow rate control inlet to an end outlet,
a first housing and a second housing coupled to said control arm, said first housing including a mixed water outlet, said second housing having a position control brake,
a first base rotatably coupled to a second base, said second base coupled to said first housing and said second housing,
wherein said control arm controls mixing of hot and cold water and water flow rate.

2. The apparatus of claim 1, said first base including a first water inlet, a second water inlet, a first water outlet and a second water outlet, wherein water flows from a first source through said first water inlet to said first water outlet, and water flows from a second source through said second water inlet to said second water outlet.

3. The apparatus of claim 1, said first base having a centering pin and a water mixing pin, said water mixing pin disposed between said first water outlet and said second water outlet.

4. The apparatus of claim 3, said second base having a centering hole, mixing groove and a mixing inlet, wherein said centering pin fits within said centering hole to align said first base with said second base.

5. The apparatus of claim 4, said water mixing pin fits within said mixing groove, wherein said water-mixing pin has a smaller height than depth of said mixing groove.

6. The apparatus of claim 4, wherein rotation of said second base in relation to said first base mixes water from a first source with water from a second source.

7. The apparatus of claim 1, wherein water flow is blocked when said control arm is perpendicular in relation to said second base.

8. The apparatus of claim 1, wherein water flows through said control arm when said control arm is positioned less than perpendicular in relation to said second base.

9. The apparatus of claim 1, further comprising:
a third housing coupled to said apparatus, said apparatus disposed within said third housing,
a flow-through coupler having an opening coupled to said control arm and said third housing; and
a faucet arm coupled to said flow-through coupler,
wherein water flows from said control arm to said flow-through coupler and out an end of said faucet arm.

10. A faucet comprising:
an outer housing having a faucet arm coupled to a flow-through coupler,
a water mixing and flow rate control device coupled to said outer housing and disposed within said housing,
wherein water flow rate and mixing of a first water source and a second water source are controlled by vertical and horizontal movement of said faucet arm.

11. The faucet of claim 10, said control device having a position control brake, a flow rate control inlet, and a water passage way through the length of said control device from said flow rate control inlet to an end outlet.

12. The faucet of claim 10, further comprising:
a first housing and a second housing coupled to said control device, said first housing including a mixed water outlet, said second housing having a position control brake.

13. The faucet of claim 10, further comprising:
a first base rotatably coupled to a second base, said second base coupled to said control device.

14. The faucet of claim 13, said first base including a first water inlet, a second water inlet, a first water outlet and a second water outlet, wherein water flows from a first source through said first water inlet to said first water outlet, and water flows from a second source through said second water inlet to said second water outlet.

15. The faucet of claim 13, said first base having a centering pin and a water mixing pin, said water mixing pin disposed between said first water outlet and said second water outlet.

16. The faucet of claim 15, said second base having a centering hole, mixing groove and a mixing inlet, wherein said centering pin fits within said centering hole to align said first base with said second base.

17. The faucet of claim 16, said water mixing pin fits within said mixing groove, wherein said water-mixing pin has a smaller height than depth of said mixing groove.

18. The faucet of claim 16, wherein rotation of said second base in relation to said first base mixes water from the first source with water from the second source.

19. The faucet of claim 13, wherein water flow is blocked when a control arm of the control device is perpendicular in relation to said second base.

20. The faucet of claim 13, wherein water flows through said control arm when said control arm is positioned less than perpendicular in relation to said second base.
